(19) United States
(12) Patent Application Publication
(10) Pub. No.: US 2003/0127105 A1
(43) Pub. Date: Jul. 10, 2003

(54) Complete compact

(76) Inventor: Richard Remo Fontana, Cape Elizabeth, ME (US)

Correspondence Address: RICHARD R. FONTANA, 14 VALLEY ROAD, CAPE ELIZABETH, ME, 04107, US

(21) Appl. No.: 10/336,095

(22) Filed: Jan. 4, 2003

Related U.S. Application Data
(60) Provisional application No. 60/345,857, filed on Jan. 5, 2002.

(51) Int. Cl. A45D 24/00; G01N 7/00

(52) U.S. Cl. 132/200; 73/23.34

(57) ABSTRACT

A sensor and display means useful for sensing personal appearance. The invention addresses aroma and presenting the characteristics of the aroma to the user in particular detail. The appearance sensor and display can be integrated with another device associated with determining another aspect of appearance. For example, an aroma sensor and display integrated with a mirrored compact would provide a convenient and complete means of inspecting critical aspects of personal presentation which are visual appearance and personal aroma. The display might also include an appointment book or similar functionality associated with meeting people so that the user is conveniently reminded to check their appearance as they are reminded of the meeting. Improvements in the design of the sensor based on controlling the flow and path of the aroma stream for reducing the size and cost of the aroma sensor are included in the invention.

### CROSS-REFERENCE TO RELATED APPLICATIONS

This application claims the benefit of Provisional Patent Application Ser. No. 60/345,857 filed Jan. 5, 2002.

### BACKGROUND

1. Field of Invention

This invention relates to devices used to inspect ones self such as the mirrored cosmetics compact.

2. Description of the Prior Art

People have used pocket mirrors and compacts for many years because they care about how they are perceived by others in society. The pocket mirror/compact is a tool to allow a person to see their own image while traveling or away from home. Typically the objective is to maintain or modify their appearance, and thus influence other's perception of them. The pocket mirror/compact (pocket mirror/compact is simplified to “compact” in the rest of this document) provides some aid in assisting people in improving how others perceive them by conveniently providing an indication of their visible appearance that might otherwise be inaccessible to them. This allows them to take action based on their visible appearance that might improve their interaction with others, be it for social activities and dating, or work and business. However, visual appearance is only one element of a person's social presentation that is not apparent to the individual but is important to how others perceive them.

In many social situations, the aroma of the person may have substantial impact on how they are perceived and whether they are accepted. Aroma can provide a powerful, unconscious favorable reaction, or a powerful unfavorable reaction. An unfavorable aroma can even result in revulsion of either a conscious or unconscious nature regardless of the visual appearance of the person, yet that aroma may not be perceptible by said person.

The existing compact is a tool for assisting a person in improving their acceptance by others, but it fails to achieve this objective completely because aroma plays such a strong role in personal interactions. The impact of this shortcoming in compacts is reduced success and acceptance in social and business settings; this in turn can reduce a person's satisfaction and success in society. This shortcoming results in frustration for those who use compacts—the information compacts provide is incomplete, resulting in an unsatisfactory outcome for many users.

Clearly what is needed in the art is a compact that provides complete information about how one will be perceived. This complete information includes both personal appearance and aroma.

### SUMMARY—THE INVENTION

This invention, a Complete Compact, provides the individual with the ability to perceive important personal characteristics that can fluctuate and are not otherwise perceptible to them. Specifically, by providing the individual with personal aroma perception, the Complete Compact provides important personal perception information required immediately before social and business interactions.

Objects and Advantages

The Complete Compact provides the advantages of the ability to measure aroma accurately and on demand, whereas a person's own sense of smell is inaccurate and inadequate for determination of their own aroma because the nose adapts to and ignores most types of persistent odors. Other people who can be trusted to provide such information are unlikely to be available when needed and may themselves be insensitive and/or inaccurate judges. The complete compact provides a convenient and reliable means of determining aroma and has considerable advantages over any currently available aroma sensing system.

In addition to the use of the complete compact for personal aroma, the compact might be applied to other aroma sensing applications if desired. Because it is anticipated that the complete compact will be relatively inexpensive, it is likely that many alternative uses of its capabilities will be found. Many such uses are included in descriptions in following sections.

### DRAWING FIGURES

FIG. 1 shows the low cost embodiment of the Complete Compact and FIG. 2 shows an exploded view of the key components.

FIG. 3 shows a section view of the rolling seal pump embodiment of the complete compact, while FIG. 4, FIG. 5 and FIG. 6 show different views of the embodiment.

FIG. 7 is the assembled view of the spiral sensor configuration. FIG. 8 and FIG. 9 show more details of the spiral sensor embodiment.

FIG. 10 is a zigzag sensor with attributes similar to a spiral sensor but more suited to linear components and FIG. 11 and FIG. 12 show another form of zigzag sensor layout that is suited to planar sensor component configuration.

FIG. 13 through FIG. 16 are drawings of the medium cost embodiment with learning option shown in different operating modes with FIG. 16 being a section view.

FIG. 17 is the medium cost embodiment with features for a trigger release to sample based on a cover button.

FIG. 18 is the full function embodiment of the Complete Compact.

### DESCRIPTION OF EMBODIMENTS OF THE INVENTION

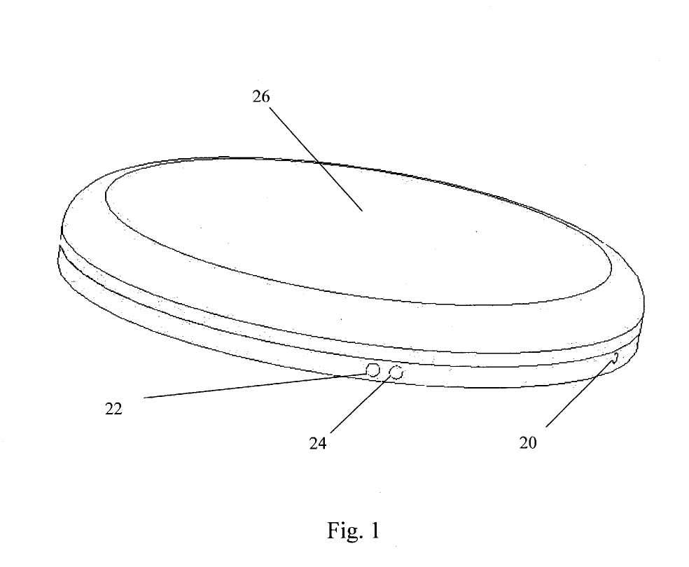

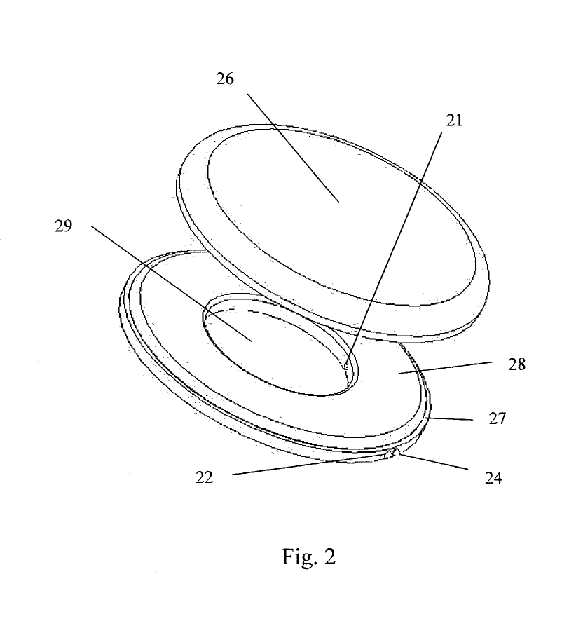

Description of the Main Embodiment, FIGS. 1 & 2—Low Cost Embodiment (Preferred Embodiment)

The most basic features of the low cost embodiment are shown in FIG. 1. This embodiment is based on a typical clamshell type compact shape that is similar to two Frisbee shaped shells joined by a hinge. The basic features are an aroma inlet hole 30, a multicolor LED display light 32, an on/off button 34, and a flexing case 36.

The production of a low cost embodiment is dependent on the fabrication and assembly technology available and the costs associated with fabrication and transportation. Therefore, the details of materials and processes often depend on the locale and they may change frequently. Rather than focus on particular materials or shapes, the focus is on the basic features required and how to integrate them with minimal extra components. Typically, minimizing the number components means minimizing the cost. The configuration shown in FIG. 2 utilizes the flexing case 36 and an aroma sensor module 38, which has a case-closing floor 39 as the air pump. The artificial nose and electronics module 38 is mounted and sealed at a bonding location 37 with the flex case 36. The aroma inlet 30 leads to the interior of the sealed space through the aroma sensor module 38 and an inner port 31.

Operation—FIGS. 1 & 2

Squeezing the flex case 36 at the center distorts the case and expels air from the case, through the aroma sensor module 38 and the aroma port 30. Releasing the case pulls air in the region around the aroma port 30, which contains the aroma sample, through the aroma sensor module 38. The artificial nose and electronics in the aroma sensor module 38 determine the characteristics of the aroma as the air with the aroma sample is sucked into the case. This general construction approach utilizes the basic components inherent to the compact, the case 36 and the aroma sensor module 38 as the primary air movement actuation and control system. The case material and decoration can be wide variety of patterns. The aroma sensor module can have a graphic visual display, be silvered on one side, or have a mirror mounted on it for to allow monitoring of the user's visual appearance. The display can, in addition or alternatively, be vibratory or tactile. A vibrator can be incorporated in the electronics module. A vibratory display might utilize a coded pattern to transmit information to the user and/or a visual display of the results can be presented on the LED display light 32. There are many options for the display of the results including transmitting light through from the backside or edge of the mirror and/or the display could use a surface mounted display technology.

To the user, operation of the embodiment of FIG. 1 and FIG. 2 is simple. Pressing and releasing the aroma sample area of the flex case 36 causes an air sample to be sucked into the sample tube 30 and triggers the artificial nose and electronics module 38 to determine the aroma of the sample. The character of the aroma is displayed to the user via the color of the LED display 32 (or by vibratory patterns using the vibratory display). For the LED example, green indicates good, yellow borderline, and red bad. The strength of the aroma can be displayed as well by blinking frequency. Thus, the user can determine the social acceptability of their aroma simply by placing the complete compact in a suitable location, pushing the test button and observing the indicator. The rest of the compact is similar to existing versions of compacts with a mirror and cosmetics, but could also include aroma modifying items such as perfumes. Because the complete compact allows the user to perceive their scent and the effect of any modifications by scented agents, the proper selection and quantities of aroma modifiers can be utilized. A more detailed description of some more complex embodiments follows.

Even for the simple low cost embodiment, there are many options for information display. These include:

Display through mirror

Display by beveled edges of mirror

Display using variations in:

Location of light

Color of light

Pattern of light

Amplitude of light

Timing of light(s)

Any combination of above that may result in an indication useful to the user or resulting in an image or symbol.

Similar display capabilities can be achieved with tactile, vibration, buzzing, mechanical display, images, etc.

Many aroma-sensing technologies work best when the sensor alternately samples the aroma of interest and a sample from elsewhere to use as a comparison. The user can control the location of the sampling port to enhance performance and/or the compact can utilize valves and check valves to control the location around the case of sample and rejection of sample. It may also be desirable to have the sample intake tube extend or swivel out from the case so that the sampling region is further from the case and the users hand. Some of these modifications are incorporated into the other embodiments.

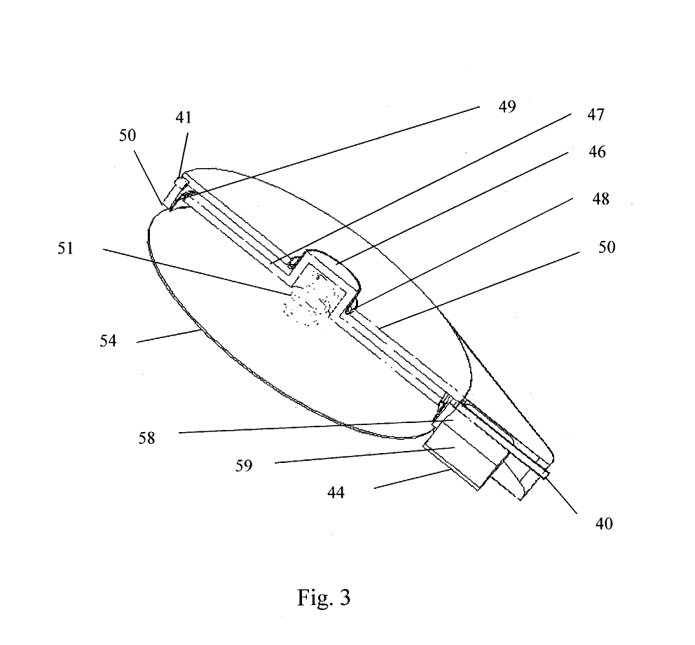

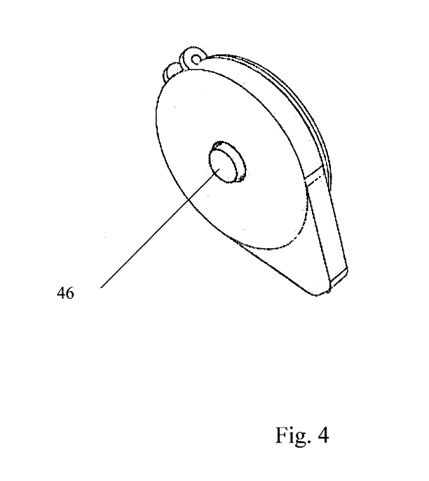

Description of Alternative Embodiments—Rolling Seal Pump Embodiment, FIG. 3 Through FIG. 6

An alternative embodiment that is more complex, but capable of pumping a larger volume of sample air/aroma through the sensor is shown in FIG. 3 through FIG. 6. In this embodiment, the aroma sample is taken when a test button 46 of FIG. 3 is squeezed. A pump piston 47 and an inner rolling seal 48 and an outer rolling seal 49 are mounted in a case 50 to provide a sealed pump suction space 49. A return spring 51 is mounted between the pump piston button and a cover plate 54. An aroma port with one-way inwards check valve 40 is connected to pump suction space 49 through a sensor system 58. Sensor system 58 is powered by a battery (or other power source) 59. A display unit 44 is connected to the sensor output processing electronics. Pump suction space 49 is connected to the outside environment through an aroma sample outlet port with one-way outwards check valve 41. Cover plate 54 is attached to the case and a case vent 52 provides passage for air on the backside of the piston.

Operation of the embodiment of FIG. 3 is performed by pressing pump button 46 that moves pump piston 47. That motion of the piston expands the suction space so that a sample from the region around one-way-valve inlet aroma port 40 is passed through the sensor system. Vent 52 provides a path for the air on the backside of the piston to escape so that the piston can move and variations in atmospheric pressure can be accommodated. Results from the sensor are displayed to the user on display unit 44; When the pump button is released, the spring returns the piston and button, which expels the air sample through one-way valve sample outlet port 41 and prepares the pump for sampling again. This pump arrangement provides aroma sampling when the button is pushed which may be more intuitive to the user than systems that provide aroma sampling with the button is released.

The complete compact integrates the aroma sensor with a mirrored compact for convenience (and camouflage). FIG. 4 shows the button side of the compact in final form. FIG. 5 shows the other side of the compact with a mirror case cover 55, shown closed in this view, mounted to the case by a hinge 56. FIG. 6 shows the complete compact with the cover open. A surface inside the cover 57 and/or the surface face of cover plate 54 can be surfaced with a mirror finish or mirror to provide the standard visual capability of a typical compact. The display 44 is visible with the case either open or closed so that the aroma sampling can be done in any orientation without spilling the contents of the compact. The compact can be used with the mirror open or closed by pressing a sample button 46 while the aroma sample port 40 is in the region of interest.

Modular Design

As previously described, FIG. 3 shows the internal components of this embodiment of the Complete Compact. The major components shown in these views are: the case and mirror; the pump and pump button; the check valves and connections; and the artificial nose and electronics module. This embodiment uses a modular aroma sensing system for convenience, low cost, long life, and ease of upgrade. The aroma system including the battery can be slid out of the case allowing any or all of the key components to be serviced or replaced if desired.

There are many artificial nose technologies available and under development. The references contain some information on where further information on artificial nose technology can be obtained. This invention can utilize one or more artificial nose technology(s) as appropriate. The artificial nose, memory, processor, display, optional vibratory display/alarm and all electronics are integrated into one module in this embodiment. The output of the artificial nose is processed and displayed on the visual or vibratory display. In this embodiment, the visual display is a multicolor light emitting diode that is integrated into the module. The module also contains the batteries, on/off switches, and control buttons. The module is designed to integrate with the previously described features of the latch; for example: the position of the on/off switch in the module when installed in the case is such that when the latch is closed it depresses the on-off control button, which turns the electronics off.

This modular construction provides cost and reliability benefits. Benefits are: the aroma system can be tested before insertion into the compact case; the same aroma system can be used in many different case designs to provide a variety of styles; there are no wire connections to make on assembly; and the entire aroma assembly or subcomponents of the assembly can be replaced if desired. The system can be designed so that the battery and/or nose components can be replaced or so that the entire module can be replaced by the user or at a service center.

Many artificial nose technologies available today have limited life components, so it may be advantageous to design the battery to last approximately as long as the life of the artificial nose. When the battery dies, the entire module is replaced and the effectiveness of the aroma sensor is thus maintained. Alternatively, it may be more appropriate to make a replaceable module in the electronics module that contains the components subject to aging and includes a means of testing to provide an indication of when the performance of the system is degraded sufficiently to warrant replacement of a subcomponent. Ideally, there will be no components that wear out other than possibly the battery; in that case the embodiment would be configured to allow the battery to be replaced or recharged by the user. A photocell or charging system could be used to recharge the battery.

It is also possible to use power sources other than a battery or in addition to a battery including: capacitors, inductors, photo cells, heat engines, chemical power sources, fuel cells, springs, inertial generators, auto winders, and radiation.

If the system includes learned data that is unique to each user, then it is appropriate to save the user's learned data. This might be done even with the modular system by many techniques including: making the battery and/or age sensitive components into a replaceable module, transfer of the memory components to the new module, transfer of the data by electrical or optical means to either a new module or a computer or handheld where the data could be used in several compacts. Whatever the limitations of the artificial nose technology, the modular approach provides advantages.

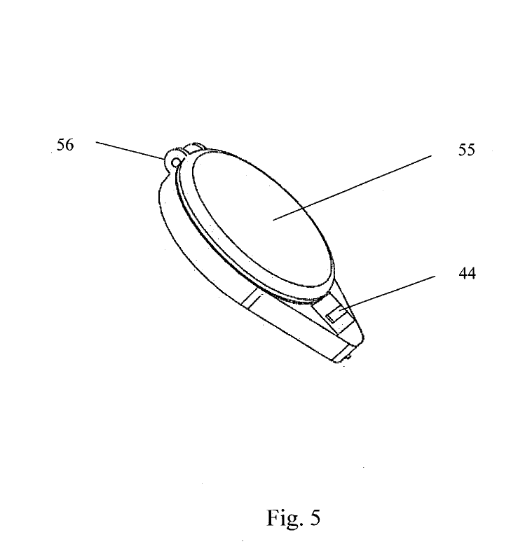

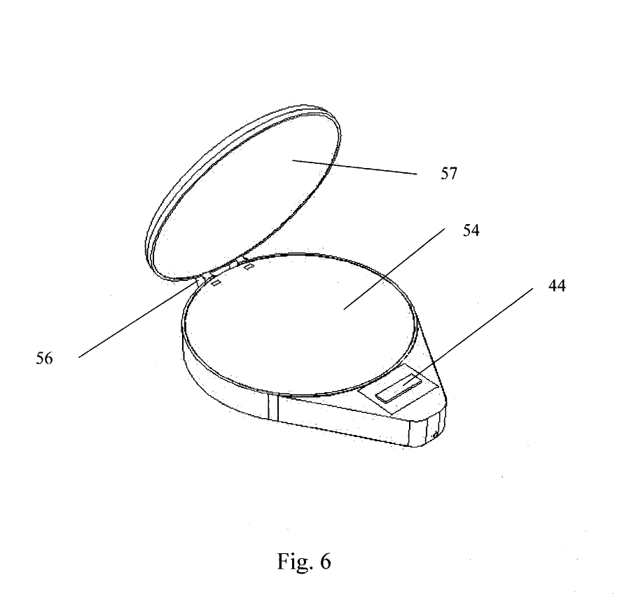

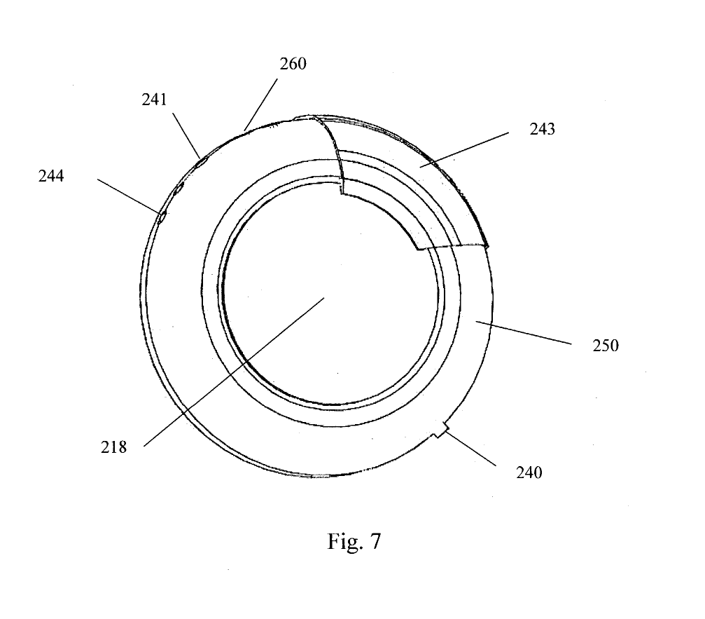

Description of Serpentine Sensor Embodiment—FIG. 7 Through FIG. 12

FIG. 7 shows the external components of the spiral sensor embodiment. An aroma intake port 240 is on one side of a squeezable outer pump case 250. A aroma port cover/control switch 243 rotates about the central axis of a central sensor module 218. An aroma sample outlet port 241 passes through outer pump case 250 opposite intake port 240. A display 244 and control port 260 are also on the case.

FIG. 8 shows the central sensor module with the cover removed to expose the spiral sensor system. Aroma port 240 leads to a spiral sample channel 270. A central emitter/detector 272 and an outer detector/emitter 274 and space for any other sensor elements 276 are in the sensor case. A sensor outer structure 278 surrounds the sensor.

FIG. 9 shows the details of the aroma sample path more clearly. On intake of the pump, the aroma enters the sensor system through the aroma intake port 240, passes through the spiral sensor section and then out through a set of check valves 286 into the pump volume. On expulsion of the aroma sample by the pump, the (spent) aroma sample passes through check valve 286 and out aroma outlet port 241.

The spiral aroma path allows a long flow path to be contained in a small volume. The idea is to get a long nose in small case. This might include a tube or channel of circular or semicircular shape, spiral tubes, screw tubes, snail shell shapes, or the labyrinth like channels of the nasal passages. A long flow path provides a large surface and flight path for the aroma sample. This allows more and/or larger sensor elements to be incorporated into the small case of the compact.

The spiral or serpentine path provides the ability to use one (or a plurality of) key sensor element(s), such as a detector (or an emitter) at the center and an array of other elements such as emitters (or detectors) around the periphery or between channels if desired. Often the expense of a component, in terms of cost, size, energy use, or some other metric, is relatively high, so the use of that component is shared my multiplexing using vlaves, switches, etc. This provides the ability to multiply use—multiplex—the component so that it can be used for several tasks nearly simultaneously. This multiplexing ability can drastically reduce the size and cost of the sensor and can also improve performance by eliminating the need to correlate two or more elements. The use of a spiral or serpentine path is particularly useful if the detector (or emitter) is very expensive because it allows it to be shared, or multiplexed, due to its central location. The spiral or serpentine path can allow this sharing to be done without valves. For example, for sensors that use optical detection technology, one expensive detector (or source) to be multiplexed among many sensor elements by locating it at the convergence of several sources and controlling the exposure to the sources so that several sources can be measured by one detector. This technique can be used on other types of sensors as well. For instance, the fluid need not be a gas. It is possible to use the same improvement in sensor geometry in a turbidity sensor for fluids, a chemical detector for liquids, a blood analyzer sensor, or any sort of analysis tool.

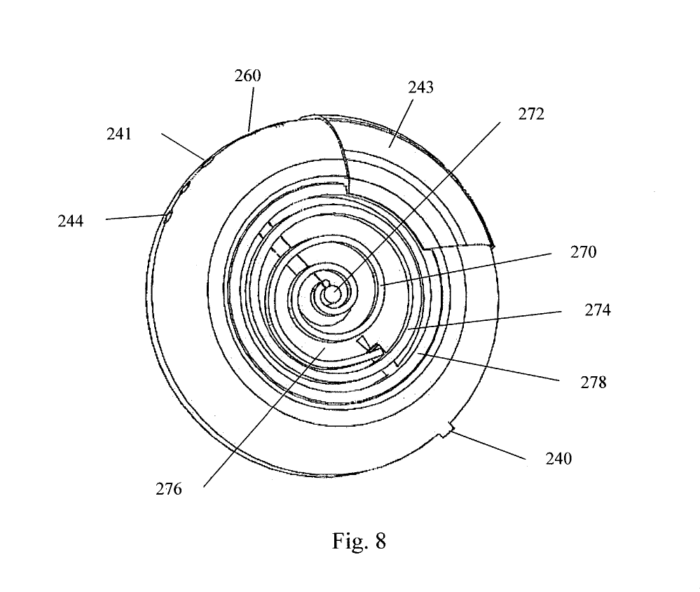

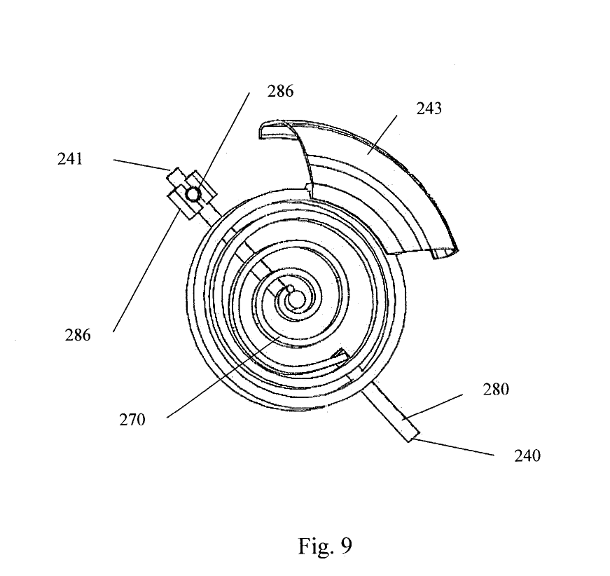

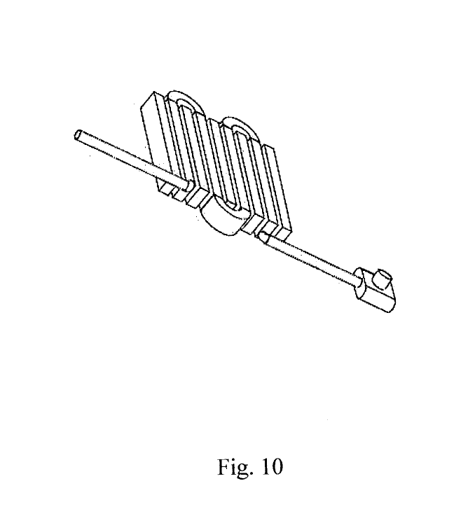

For example, the source might be a aroma specific optical filter and different filters and light sources and paths could use the same detector easily using the spiral (or serpentine) arrangement. In the situation where the detector is expensive, the emitter(s) can be pulsed sequentially or in any known pattern so that the same detector can be used for many detection paths and/or types of detectors. This is a form of multiplexing. In addition, control switch 243 can be used to control the aperture and or optical path as desired. There is space between the spiral channels for lenses and/or filters. Other types of sensors can also be integrated into the flow path and take advantage of the spiral path. It is also worth noting that a circular and/or serpentine path rather than a spiral can be used if desired. A serpentine path in the form of zigzag path as shown in FIG. 10 might be used if linear or flat sample elements fit the application. A staggered plate configuration, as shown in FIG. 11 with the exterior sealing box removed, provides a means of packing many sensors in a manner that is compact and inexpensive to assemble. FIG. 12 shows the configuration in a sealing box where an inlet (or outlet) port 290 provides a path into the labyrinth passage of the sensor and the aroma-sensing path passes over the surfaces of the plates as it moves through the sensor, providing a means of determining both spatial and temporal information on the aroma. The staggered plate configuration provides a compact, low cost means of incorporating semiconductor beam-based sensors into a sensor aroma path. If the connector density is low, proper edge connection spacing allows the staggered the plates to be easily connected to a data bus.

Controlling the flow path can provide many opportunities for improving sensor performance and/or reducing sensor cost including: multiplexing at least one sensor, sharing the output of at least one source, sharing at least one detector, providing multiple layers of sensor surfaces, providing a smaller sensor, providing ease of construction, allowing shared sensor elements, providing high surface area, reducing surface area, increasing quantity of sensor elements, increasing quality of sensor output, increasing time of flight, reducing time of flight, providing consistent flow patterns, improving spatial flow consistency and improving temporal flow consistency. For sensing systems that use spatial and temporal aspects in sensing aroma, controlling the flow pattern can have a substantial impact on performance.

Ways of producing specific flow patterns such as circular, semi circular, spiral, serpentine, zig-zag, labyrinth, swirl, choked flow, sonic flow, venturi flow and vorticity include:

In some cases, such as high density edge wiring or optical interactions between plates, it is better not to stagger the plates and provide a baffle arrangement similar to that of FIG. 12 at the ends of the plates, but have the plates line up or be staggered in a step pattern. Using aligned plates is suitable for using an edge connecting bus structure with individual, parallel, or serial addressing. Whereas using a stair step pattern is suitable for an edge connecting structure with individual data lines because a the connections can be at a consistent position on the edge and connect with a line that crosses other plates without connecting.

The spiral sensor can also be useful for surface sensors that are flexible or segmented so that they can be rolled up to form a compact sensor. A zig-zag or serpentine arrangement also provides a means of packing a large sensor into a small case that can be easily constructed from flexible or segmented sensor components.

A duct shape with a vorticity inducing channel or vanes might also improve the flow pattern, enhancing mixing and/or stratifying the flow by rotational pressure gradient. Enhanced lateral mixing can improve the temporal and spatial measurement response. Suitable features might include rifling, dimples, vanes, steps, ridges, roughed surfaces, etc. In addition to steady flow, unsteady flow can improve the mixing of the boundary layer in a flow. The pulsed nature of a pump can impact the flow dramatically. Using one or more features such as: spirals, sections of a circle, substantially parallel plates, zig-zag flow paths, dimples, rifling, rifling, dimples, vanes, steps, ridges, roughed surfaces, and labyrinths, steady flow, unsteady flow, pulsed flow, choked flow, restrictor plates, turbulators, and baffles provides a variety of ways to influence sensor size and performance.

Some of the aroma sensor technologies currently under development or available can be found by searching for “artificial nose” one the world wide web. These include optical based and semiconductor cantilever beam based sensor technologies, among others. A sensor can determine the characteristic of an aroma based on presence or absence of a molecule in concentration above a limit, or a sensor might have an output that can also determine concentration levels. Some aroma sensor elements are specific to particular molecule, and others are sensitive to more that one molecule. There are many aroma sensing technologies with various types of outputs. Aroma sensors may include temporal and spatial aspects in their operation. The aroma sensor means may be based on and/or contain one or a plurality of aroma sensing devices and/or technologies. The output from a plurality of sensor can be combined to provide enhanced capability. The processing of the outputs of sensor elements to determine the aspects of the characteristics of aroma to display to the user may be preprogrammed or learned or some combination of both. Learning is an important aspect of the aroma system and is described in more detail elsewhere.

A surface mounted aroma sensor might be mounted on the case with or without a protective cover and might need no pump. Such a compact could be waved in the vicinity of the area of interest to determine the aroma and could eliminate the need for a pump. This allows a very simple compact where the sensor could be mounted almost anywhere on the surface of the case.

The pump for the compact may be a motorized pump of any type, or, particularly for the spiral embodiment shown, the side of the pump case can be made flexible and sealed to act like an eyedropper-like pump to provide pumping action through the check valves. Sniffing action of the compact might be performed in many ways with many technologies, for example, diaphragms and actuators, piezoelectric fans. A list of potential pump technology includes: bellows, diaphragm, piston, turbine, bulb, fan, blower, roller, peristaltic, electrostatic, piezoelectric, and centrifugal means of pumping. The type of pump can influence the flow, and can therefore affect sensor performance. Ideally perhaps, no air pump would be required, for example polymer semiconductor technology could integrate the electronics, nose, and display and battery on the surface of the compact.

The electronics and battery are located in the case for the described embodiment. Power supply might be from batteries, piezoelectrics, capacitors, moving weight generators, self-winders, fuel cells, etc. These might allow manual operation of the sniffing action to be eliminated. Charging systems for the power source might include photo cells, direct plug in, inductive or capacitive chargers, thermal engines or thermopiles, etc.

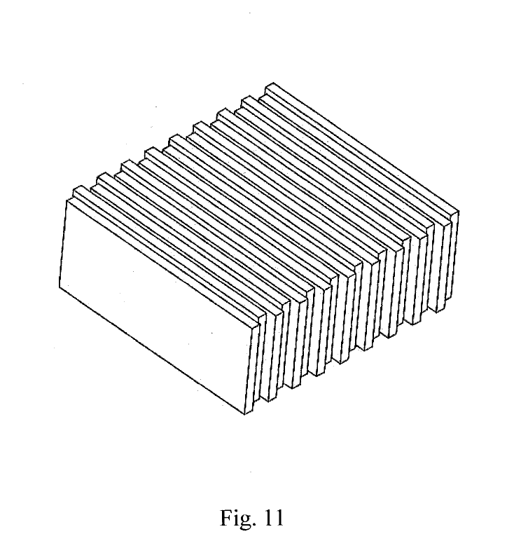

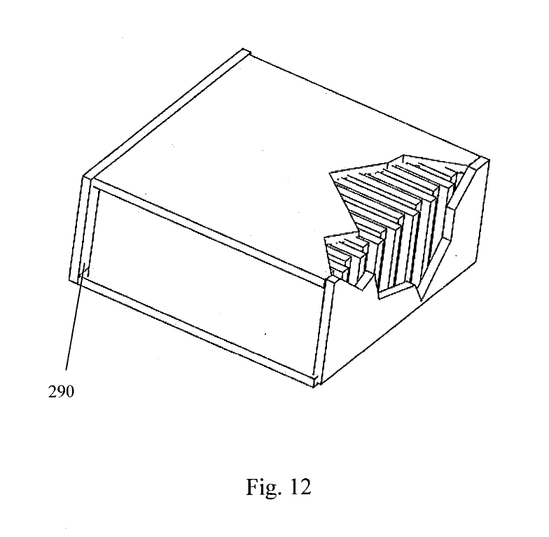

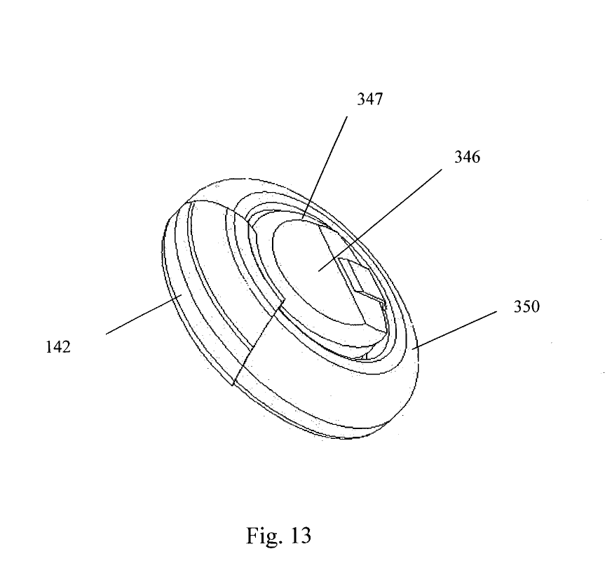

Description of Alternative Embodiments—the Medium Cost Embodiment with Learning Option—FIG. 13 Through FIG. 17

The Medium Cost Embodiment is described below from the outside in. First the basic shapes and mechanisms apparent to the user are described, and then the internal components are described. Many variations on the layout are possible. This embodiment describes the components in a configuration that achieves the basic functionality of the Complete Compact. The invention is not limited to the embodiments shown.

FIG. 13 shows the Complete Compact in the closed and locked position. An outer case 350 is shown closed and latched by a control/latch 342 with a bellows pump 347 compressed. Most artificial nose technologies require an air sampling action to bring the air sample into the sampling region. Bellows pump 347 is actuated by the aroma sample button 346 in the center of the compact. Latch 342 is in the off position in FIG. 13. In this position the electronic components are turned off so that the power supply is not drained. The latch holds the bellows pump closed to minimize the size and cover aroma system components.

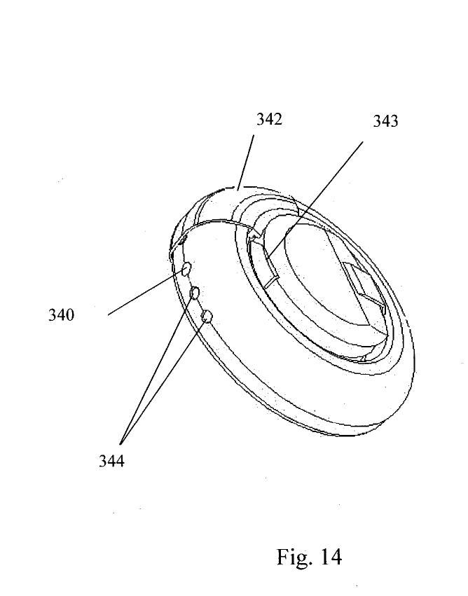

FIG. 14 shows the latch in the sample-enabled position. A display 344 and the aroma sampling port 30 are exposed and a bellows closing cam tab 343 is released.

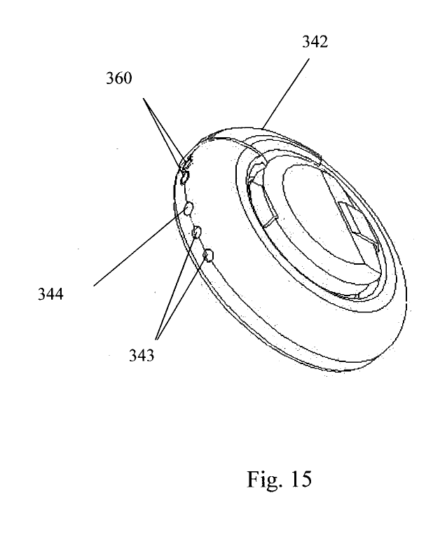

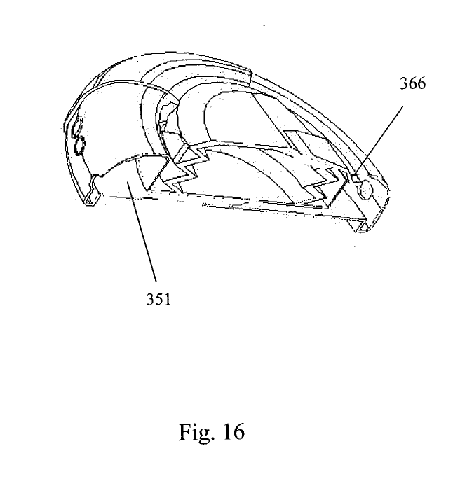

FIG. 15 shows latch 342 open to fully expose an aroma control port 360 and a learning port 361. FIG. 16 is a section view showing a bellows hinge 366 and the cavity in the case where the aroma sensor system and related plumbing is located.

Operation of the embodiment of FIG. 13 through FIG. 16 is controlled by the position of the latch. The latch in the closed position (FIG. 13) is used to prevent accidental mode changes and damage, and seal the aroma sample intake port to keep out contaminates such as lint and dust. In the position shown, the latch also secures the compact in the closed position.

FIG. 14 shows the latch in the sample position. This provides automatic aroma sampling when the device is turned on by releasing the bellows, which expands, due to its own springiness (or that of a spring in the bellows), sucking in an aroma sample. The hinge 366 provides support for the other side of the button to fully constrain the motion to in and out pumping motions and to prevent the rotation of the button when the latch is moved.

FIG. 14 shows the latch in the position for use of only the aroma sampling and display aspect of the Complete Compact with the main hinge of the compact closed. This latch position allows the Complete Compact to be positioned appropriately to sample aromas without the risk of spilling the contents of the clamshell. As shown in the right sketch, the latch is rotated clear of the intake port so that it is no longer sealed, and the tab that constrained the bellows button has moved so that the bellows is released. This automatically takes an aroma sample. The test button can then be actuated at will at any time by squeezing the bellows. Moving the latch to this position also enables the electronics. In this embodiment, pressing and releasing the test button results in aroma sampling by the artificial nose. The results of the artificial nose's analysis of the aroma may be displayed as a color and pattern on the display LED and/or as a vibratory pattern from a vibratory element. In this configuration the compact can easily and discreetly be used to sample specific aromas without risk of the contents of the compact spilling.

FIG. 15 shows the latch in the fully open position. In this position the control and learning ports are exposed. As a design option, the latch can incorporate a cam near the end of the stroke that pries the clamshell case open slightly so that the case is easily opened. (Alternatively, a separate latch can be used to constrain the mirror so that the functionality of the aroma and mirror systems is independent.)

The clamshell case opens as shown in the left sketch of the Figure. Now all of the functionalities of the compact are available. In this embodiment, there is a mirror mounted on the inside of the half clamshell that houses the bellows and artificial nose. Cosmetics and aromatic agents are located in the other half of the clamshell. The latch is designed so that even with the compact open, the latch can be moved to the off position to seal the intake port and prevent power drain and aroma sampling if desired, and the clamshell can be snapped fully closed with the latch in any position for convenience.

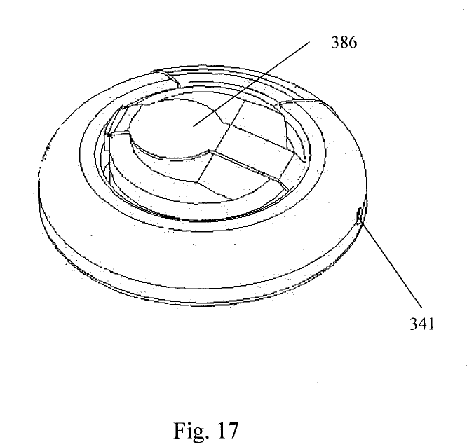

It is anticipated that the artificial nose performance will be improved if the aroma sampling action is well controlled. The flow rate may be controlled by designing a portion of the flow channel with a sonic flow venturi, baffle plate, or similar feature, so that the flow is “choked”—sonically limiting the flow rate, or by controlling the motion of the pump. Choked flow can be induced by a number of means including a venturi or a constriction in the flow path. The flow path might also be controlled to produce regions of turbulent flow for enhance mixing, laminar flow for reduced mass transfer, and high vorticity flow for swirling the aroma molecules. The sampling operation of the bellows, as described to this point, is directly controlled by the manner in which the user releases the test button. This embodiment can achieve a consistent sniffing action by incorporating a latch and release mechanism. There are many latch and release mechanisms, such as those in trigger mechanisms, any number of which can be adapted to use in the compact. The compact show in FIG. 17 is based on the previously described bellows pump compact, but differs in that there is a top button trigger 386. Depressing the bellows button, via the top button trigger, cocks the bellows in the compressed state. The test button is separate from the bellows itself and is spring loaded so that when the user releases the button, the bellows is held by the latch as the button moves away. When the top button trigger nears the end of its release stroke, a cam arm on the button releases the bellows latch and the bellows is free to expand fully at a rate governed by its own stiffness (and the expanding spring's if one is used) and the flow restrictions of the intake flow path. Thus, the aroma sample flow can be made consistent even with manual operation of the pump. (Manual operation of the pump is expected to result in significant reduction of the power requirement of the system and thus reduce battery size and/or extend battery life.)

Variations in Design Details to Match Sensor Requirements

The test button allows the bellows to be squeezed and released. Squeezing the bellows drives air out of the bellows, through the outlet check valve, and out of the outlet port. Releasing the button allows the bellows, which is spring-loaded, or is designed to expand due to residual stress, to expand. As the bellows expands, the outlet check valve closes and air is sucked through the inlet check valve on the inlet side. The air sample passes through the artificial nose where the aroma is determined as it is sucked into the bellows. This configuration is useful if the artificial nose performs best when the aroma samples pass in one direction through the sensor. For artificial noses that work best with oscillating flows, the check valves can be eliminated and all flow, both in and out, can occur through the artificial nose element. The flow can enter/exit through a single inlet/outlet hole, or it can be divided or redirected by passive or active flow elements incorporated to direct the airflow as desired entering or exiting the case. As an example, a short extension or tube may enhance aroma detection by reducing the pickup of scents from lotions or perfumes on the user's hands.

Learning Mode for the Complete Compact

Learning Mode is likely to be a desirable option for the Complete Compact. It is possible that many people will have a special need to train the Complete Compact. For example, many people might like to correlate the favorability of an aroma with the tastes of those with whom they associate so that the Complete Compact will be able to indicate as acceptable or unacceptable certain aromas based on a particular person of groups aromatic opinions. For example, some strong perfumes may be unacceptable to most of society, but socially acceptable in an individual's peer group. They would need to utilize the training option and train the Complete Compact to accept the aroma of that strong perfume rather than signal an unacceptable aroma. As an example of actual implementation, an embodiment-of the basic components and procedure for training are described as follows:

1. A sample of the aroma to be trained is tested by the user.

2. A judgment of the aroma as good, unimportant, or bad is indicated to the unit by pressing appropriate control buttons, or the system could be configured so that an affirmative tap classifies the aroma sample as good or a frustrated squeeze or shake classifies the aroma as bad.

3. The artificial nose data-processing algorithm is updated accordingly and stored as the user's preferences.

4. The process is repeated as required.

Learning mode can be used to learn whether certain aromas are favorable or unfavorable or to allow certain aroma components, such as a favorite hand lotion, to be ignored or specially considered in the aroma judgment process. The learning mode might also utilize a database that could be loaded to and stored in the compact.

By repeating the learning procedure for many situations, the Complete Compact can be trained to match the aromatic preferences of the user or the user's social group. The capability could be used for perfumes, which tend to vary in aroma depending on the individual and the condition of their skin.

Learning mode might not always be targeted to a human. An animal, such as a cow, pig, horse, dog, cat, ferret, insect, fish, or any living thing might have aroma preferences that could be learned by the complete compact. Similarly, plants, bacteria, and other living things might change their characteristics based on exposure to aroma. There is substantial evidence that aroma plays an important role in the plant response to insects and visa versa for instance. There are also other processes not involving life that can benefit from the aroma learning capability of the complete compact including chemical processes, manufacturing processes, and breakdown and/or recycling process. Learning mode is at the heart of many alternative uses for the complete compact.

There are other options that can be incorporated into the Complete Compact some of which would depend on the level of sophistication of the artificial nose technology or technologies used. For example, it may be possible that the artificial nose is not capable of separating different components of aroma that matter adequately to indicate the corrective action accurately without a mode switch to classify the aroma sample. In this case only one display is required, but a switch is required to set the Complete Compact in the appropriate mode. If the artificial nose can discern each component and ascertain the source, it may be desirable to have multiple displays. Still, a simple version that relies on the user's judgment on where they have taken the aroma sample may be adequate for aromatic discrimination. This provides a minimum number of buttons. Simplicity is often an advantage in a consumer product such as the Complete Compact. The best configuration for the Medium Cost Embodiment is likely to depend on the state of artificial nose technology, cost, and availably. The design will be based on the sensor technology available. At this time the technology described in the reference [H. P. Lang] is one possible compact sensor suited to this application.

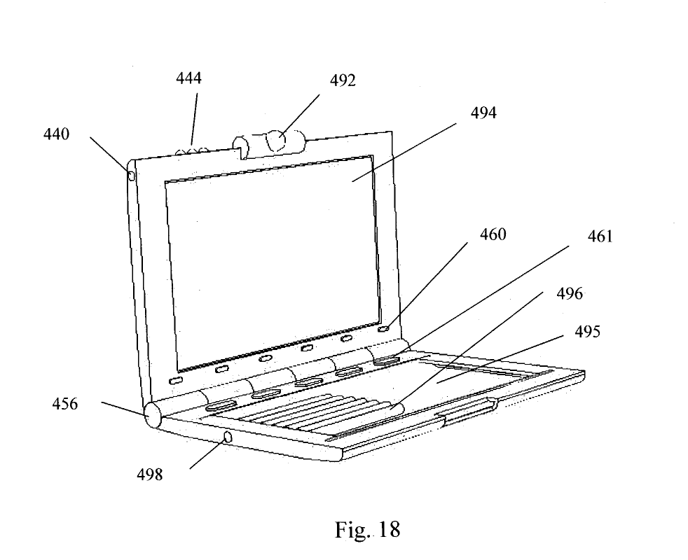

Description of the Full Function Embodiment with Learning Option—FIG. 18

This description of the Full Function Embodiment of the Compete Compact builds on many aspects of the previously describe embodiments. Compact design includes fashion, so the exact configuration of the case and components is subject to change. A Full Function Embodiment based on a rectangular shape, with a hinge 456, is illustrated in FIG. 18.

In addition to the features, such as an intake port 440, and functionality of the previously described compact in terms of the use of the display lights and latch, this design incorporates one or more of the following:

A display method 494 incorporating one or more of the following:

1. An appointment book

2. A personal contacts list

3. A calendar

4. E-mail display

5. Map display

6. Day planner

7. Or similar information

To assist with display of many different functions the Compact might include:

1. A display screen 494

2. A display light 444 visible with the case closed

3. A mode control button or several mode control buttons 460

4. A learning/programming button or buttons 461

5. A touch screen 494 and/or touch keyboard area 495

6. One or more data transfer technologies

7. A personal digital assistant functionality

8. The ability to interface with a personal digital assistant or computing system.

These functions are valuable for a Complete Compact because it is appropriate to quickly check for windblown hair, a tie out of place, or body aroma before making personal contact arranged and recorded in the appointment display. Automatic aroma detection on opening the hinge is one optional feature of this embodiment. This may be achieved by utilization of a trigger mechanism as previously described or by requiring the aroma sample button be pushed to undo the latch. By combining the Complete Compact features and appointment calendar, whether on a piece of paper or on a data screen, the user is automatically reminded of their appearance and aroma when they check their appointments, and of appointments when they check their appearance and aroma. These complementary capabilities integrated into one device improve the likelihood of making a favorable impression whether it is by indication to the user that they need to straighten their hair or adjust their aroma, or that they have an appointment coming up that they may have forgotten about.

Additional functionality might include:

1. A camera 492—in addition to or as a substitute for the mirror. A camera with or without or with controllable image flipping (so that the image behaves more like a mirror) and zoom capability combined with a high quality display allows the functions of a mirror and close-up mirror to be achieved without a mirror if desired.

2. The screen/display 494 that can be turned into a mirror

3. A flip up cosmetic cover that is also a screen or mirror or a close-up lens or mirror

4. Wireless link and/or headphone jack

5. Speaker

6. Microphone

7. Vibrator and/or tactile signal

8. An aroma supply 496

9. An aroma dispenser 498

With the above functionality, one or more of the following options becomes possible:

1. Music and/or video and/or image display

2. Music and/or video and/or image record

3. Voice record

4. Voice recognition and/or voice command

5. Audio/voice display and/or description of data

There are many forms of information that additional communications capabilities included in the functionality of the complete compact may be useful to the user in combination with the compact. These include:

wireless communications

cellular phones

appointment information

calendars

schedules

alerts

alarms

events

pages

messages

data storage

audible information

tactile information

data recovery

data entry

clock

timer

photographs

images

moving pictures

music

shopping information

maps

aroma modifying instructions

other data

The Full Function Complete Compact can provide enhanced display capabilities such as:

1. Vibratory and/or tactile signaling—for discreet indication of the aroma of the individual or an aroma alarm for example.

2. A graded aroma rating for several aroma components simultaneously.

3. The ability to learn and judge a variety of aromas.

4. The ability to name and categorize aromas, which provides expanded uses.

With the addition of one or more of the processing power and display features described above, additional features might even give some options on what to do to improve a specific aspect of aroma to achieve the desired objective. Inclusion of pheromone categorization and detection might lead to specifically targeted perfumes for instance.

Scent Packs

The scent pack feature, packets of aroma modifiers and/or aromas can be incorporated into the compact

It is possible to add many features such as:

Advice mode—what to do about an aroma or a problem

Some way to be more specific as to what the problem is

Sampling button to control where aroma sample is taken

Some capabilities that can be incorporated into the compact include:

Learning the characteristics of the user

Calibration features

Component repair and replacement

Recalibration features or procedures

Aging adjustments for compact components and user

Discreet display

Vibratory display

Integrated display and electronics

Mounted on glass

Just the aroma component without others

Other issues related to the visual aspects of compacts might also be improved. For example, the quality of light might be controlled, or the display might be modified to account for the lighting so that an appropriate image is displayed. To make the idea of display more complete, one common display technique that is appropriate to aroma is a bar graph where the range of acceptable for various components can be marked and the actual magnitudes of various components can be displayed. This same display format provides guidance on aroma modification as well, since one or more bars might represent an aroma modifier that people can actually dispense to achieve their desired objectives.

One type of display might actually simulate the aroma in some way. This has been tried in computer driven versions by researchers. Since it involves producing an aroma, and may be producing an aroma to which the user is desensitized, it may not be the best approach for the compact. Some type of direct nerve or brain interaction might be the ultimate display. Until that technology is adequately developed, there are a variety of display techniques, such as bar graphs, lights, audible output, simple vibratory signals, etc. that will suffice for the complete compact display.

Software is likely to be an important aspect of the complete compact sensor and display system. The software that controls the aspects of the system performance and display might be personalizable and/or transferable.

There are many potential alternative uses of the complete compact such as determining the ripeness of produce or the presence of bacteria or toxins by the aroma.

Sensing of Aromas Not Apparent to the User

Many aromas may not be consciously apparent to the user. This could be because the user is unable to sense the aroma at all, for instance this is the case with carbon monoxide. This could also be the case when the sensing capability is present but is subconscious, such as is the case for pheromones. This could also be the case when the user would normally be able to sense an aroma, but they are either used to it or other aromas overwhelm the aroma of importance. This might be the case for gradual buildup or chronic exposure to fumes.

Allergens, and similar irritants, can present a case of unconscious sensitivity where the user is not consciously aware of the presence of the allergen until the allergic response has been triggered. Clearly, being aware of an allergen before the allergic reaction begins could provide the ability to avoid exposure or further exposure. When an allergy is life threatening, the ability to sense and warn of allergens could be crucial. This is a case where an alarm mode, alerting the user to a potential problem, would be useful. This type of situation is and example in which teaching the compact to look for allergens might be done at a doctors office, from a database, and/or by installing specific sensors for that user.

Science is discovering more about aromas all the time and the complete compact can incorporate these discoveries to the benefit of the user. There may be aroma clues about the onset of seizure or heart attack. There are other aromas that might be important to the user, yet the user might be unaware of their presence or quantity for which the complete compact could be used to measure and display including: biological molecules related to genetic characteristics, hazardous molecules, healthful molecules, unhealthful molecules, and other elements and molecules for which the user is not consciously or reliably able to sense, yet might be subconsciously or otherwise influential or have physical relevance to health. The complete compact with targeted sensors and/or learning mode for aromas that may not be consciously apparent to the user may be very important to the user. Clearly, the complete compact has many uses related to aromas for which the user is unable to sense as well as for aromas that the user is able to sense.

In addition to alternative uses of the complete compact, the incorporation of any of the appointment display, calendar, and communication means into a compact without an aroma sensor is an addition to the completeness of a compact. Any aspect of the complete compact without the aroma sensor that is added to the compact for visual inspection is also part of the invention. Thus, the features shown FIG. 18 and or described in the embodiments make the compact more complete even if the aroma sensor is not included in the package and this is part of the invention of the complete compact.

Advantages and Alternative Uses

There are many potential uses for the complete compact such as determination of the aroma and display of important characteristics of the:

Body

Breath

Perfume

Pheromone

Food quality

Allergens

Toxins

Chemicals

Reactants

Ripeness

Biological agents

It is expected that, with the learning mode, people will find many alternative uses for the aroma feature of the complete compact. It is also possible that the learning capability can be adapted to use by animals to investigate animal behavior or improve animal care.

Conclusions, Ramifications, and Scope

Accordingly, the reader will see that the complete compact of this invention provides the user with the ability to ascertain aspects of their appearance or presentation, specifically aromas, that they are otherwise incapable of perceiving accurately. Incorporation of aroma sensor system with the compact's ability to perform visual inspection, the standard compact, provides the capability in the same unit already associated with checking and modifying appearance.

The compact can be “trained” to learn what aromas are desirable and undesirable. The complete compact can also provide storage and/or dispensing of aromas/aroma modifiers so that the aroma “appearance” can be changed. The complete compact provides a means of checking the result of these changes as well. An aroma may contain one or a plurality of chemical ingredients. It is also possible for the advanced version of the complete compact to utilize a database and computation to assist with the selection and mixing of the available aroma modifying compounds based on the current state of the aroma and a learned knowledge base of the response to the modifiers.

Examples of techniques for modifying aroma that might be included in the compact and for which instructions in use and/or automatic dispensing based on the sensed aroma. There are many ways to modify aromas including adding additional aroma or a different aroma, modifying the aroma source, and removing the aroma source. Some ways to do this that might be appropriate to incorporate in the compact include: perfume, pheromones, cleansing agents, antibacterial agents, a culture of bacteria, a culture of virus, biological materials, a source of electromagnetic radiation, a laser, an infra-red light, a UV light, chemical agents, catalysts, drugs, and cleaners.

Although the description above contains many specificities, these should not be construed as limiting the scope of the invention, but as merely providing illustrations of some of the presently preferred embodiments of this invention. For example, the compact may have many other shapes and/or features such as octagonal, elliptical, or even be integrated into a cell phone. The sensors may be of any form and in any location. The operation can be manual and simple, or sophisticated and automated, etc.

Thus the scope of the invention should be determined by the appended Claims and their legal equivalents, rather than by the examples given.

I claim:

1. A method for determining aroma comprising:
(a) providing at least one means of aroma sensing capable of approximately discerning the presence or absence of at least one characteristic of the aroma,
(b) sampling aroma with said aroma sensing means,
(c) discerning said aroma characteristic,
(d) providing at least one means of display capable of communicating at least one aroma characteristic to a human operator,
(e) displaying at least one said aroma characteristic using said display means, whereby at least one said characteristic of the aroma can be indicated to a human.

2. The method of claim 1 further including moving aroma sample into and out of aroma sensing region.

3. The method of claim 1 further including communicating at least one form of information selected from the group consisting of wireless communications, cellular phones, appointment information, calendars, schedules, alerts, alarms, events, pages, messages, data storage, audible information, tactile information, data recovery, data entry, clock, timer, photographs, images, moving pictures, music, shopping information, maps, aroma modifying instructions and other data.

4. The method of claim 1 further including inducing at least one flow pattern selected from the group consisting of circular, semi circular, spiral, serpentine, zig-zag, labyrinth, swirl, choked flow, sonic flow, venturi flow, turbulent, laminar, swirling, and vorticity laden.

5. The method of claim 1 further including providing geometric means of multiplexing elements of aroma detecting means.

6. The method of claim 1 further including learning the preferences of an operator.

7. The method of claim 1 further incorporating data on aroma characteristics including at least one said aroma characteristics selected from the group consisting of those not consciously sensed by user such as might be selected from the group consisting of pheromones, allergens, biological molecules related to genetic characteristics, carbon monoxide, hazardous molecules, healthful molecules, unhealthful molecules, and other elements and molecules for which the user is not consciously or reliably able to sense, yet might be subconsciously or otherwise influential or have physical relevance to health.

8. A means for monitoring personal appearance comprising:
(f) at least one means for sensing at least one physical characteristic,
(g) at least one means of display of at least one said physical characteristic.

9. The personal appearance monitor of claim 8 further including at least one aroma sensing means.

10. The personal appearance monitor of claim 8 further including at least one means for computing relevant aroma components from multiple aroma sensor elements.

11. The personal appearance monitor of claim 8 further including modifying means for aroma selected from the group consisting of perfume, pheromones, cleansing agents, antibacterial agents, a culture of bacteria, a culture of virus, a biological material, a source of electromagnetic radiation, a laser, an infra-red light, a UV light, chemical agents, catalysts, drugs, and cleaners.

12. The personal appearance monitor of claim 8 further including means for computation of relevant aroma components from temporal variation in output from said personal appearance monitor.

13. The personal appearance monitor of claim 8 further including means for learning the preferences of at least one entity selected from the group containing a human, an animal, a plant, bacteria, virus, a manufacturing process, and a breakdown process.

14. The personal appearance monitor of claim 8 further including at least one means of communicating information selected from the group consisting of wireless communications, cellular phones, appointment information, calendars, schedules, alerts, alarms, events, pages, messages, data storage, audible information, tactile information, data recovery, data entry, clock, timer, photographs, images, moving pictures, music, shopping information, maps, aroma modifying instructions and other data.

15. The personal appearance monitor of claim 8 further including a means of controlling the location of acquisition of aroma sample.

16. The personal appearance monitor of claim 8 further including a means of manually powering at least one functional aspect.

17. The personal appearance monitor of claim 8 further including means for manually operating aroma intake means said intake means selected from the group consisting of bellows, diaphragm, piston, turbine, bulb, fan, blower, roller, peristaltic, electrostatic, piezoelectric, and centrifugal.

18. The personal appearance monitor of claim 8 further including a means of providing power to said sensor selected from the group consisting of batteries, capacitors, inductors, photo cells, heat engines, chemical power sources, fuel cells, springs, inertial generators, auto winders, and radiation.

19. A method of improving sensor design comprising:
(a) inducing the motion of the fluid in the sensor to flow in at least one geometrical pattern selected from the group consisting of circular, semi circular, spiral, serpentine, zig-zag, labyrinth, swirl, choked flow, sonic flow, venturi flow and vorticity,
whereby said geometrical pattern providing at least one functioning selected from the group consisting of multiplexing at least one sensor, sharing the output of at least one source, sharing at least one detector, providing multiple layers of sensor surfaces, providing a smaller sensor, providing ease of construction, allowing shared sensor elements, providing high surface area, reducing surface area, increasing quantity of sensor elements, increasing quality of sensor output, increasing time of flight, reducing time of flight, providing consistent flow patterns, improving spatial flow consistency and improving temporal flow consistency.

20. The method of claim 19 further including providing the means of inducing said motion of the fluid by incorporating at least one feature selected from the group consisting of spirals, sections of a circle, substantially parallel plates, zig-zag flow paths, dimples, rifling, rifling, dimples, vanes, steps, ridges, roughed surfaces, and labyrinths, steady flow, unsteady flow, pulsed flow, choked flow, restrictor plates, turbulators, and baffles.
